(19) United States
(12) Patent Application Publication
(10) Pub. No.: US 2007/0058123 A1
(43) Pub. Date: Mar. 15, 2007

(54) Liquid crystal display

(75) Inventors: Yoon-Sung Um, Yongin-si (KR); Jae-Jin Lyu, Yongin-city (KR); Hyun-Wuk Kim, Yongin-si (KR); Hee-Wook Do, Suwon-si (KR); Seung-Hoo Yoo, Seongnam-si (KR); Kang-Woo Kim, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/522,457

(22) Filed: Sep. 15, 2006

(30) Foreign Application Priority Data
Sep. 15, 2005 (KR) 10-2005-0086168
Jun. 16, 2006 (KR) 10-2006-0054298

(51) Int. Cl. G02F 1/1343

(52) U.S. Cl. 349/144

(57) ABSTRACT

A liquid crystal display includes: a transparent substrate, a transparent conductor formed on the transparent substrate, a gate line formed on the transparent conductor, a data line intersecting the gate line and a pixel electrode formed on a pixel area defined by the gate line and the data line. The pixel electrode includes a first sub-pixel electrode, a second sub-pixel electrode, and a third sub-pixel electrode. In addition, the liquid crystal display further includes a switching element electrically connected to the gate line, the data line, and the pixel electrode. The first sub-pixel electrode and the second sub-pixel electrode are electrically connected to each other, and the third sub-pixel electrode is isolated from the first and second sub-pixel electrodes.

### CROSS-REFERENCE TO RELATED APPLICATION

This application claims priority to Korean Patent Applications Nos. 10-2005-0086168 and 10-2006-0054298 filed on Sep. 15, 2005 and Jun. 16, 2006, respectively, the entire contents of which are hereby incorporated by reference herein in their entirety.

### BACKGROUND OF THE INVENTION

(a) Technical Field

The present disclosure relates to a liquid crystal display.

(b) Description of the Related Art

A liquid crystal display (LCD) generally includes an upper panel provided with a common electrode and color filters, a lower panel provided with thin film transistors (TFTs) and pixel electrodes, and a liquid crystal layer interposed there between. The pixel electrodes and the common electrode are supplied with different voltages to generate an electric field in the liquid crystal layer that determines the orientation of liquid crystal molecules therein. As the orientation of the liquid crystal molecules determine the transmittance of incident light, the LCD can display desired images by adjusting the voltage differences between the two electrodes.

A liquid crystal display also includes switching elements connected to the respective pixel electrodes, and a plurality of signal lines such as gate lines and data. Lines for controlling the switching elements and thereby applying voltages to the pixel electrodes.

Among the LCDs, a vertically aligned mode LCD, which aligns the major axes of the liquid crystal molecules perpendicular to the upper and lower panels in the absence of an electric field, is spotlighted because of its high contrast ratio and wide reference viewing angle. The reference viewing angle may be defined as a viewing angle making the contrast ratio equal to about 1:10 or as a limit angle for the inversion in luminance between the grays.

A wide reference viewing angle of the vertically aligned mode LCD can be realized by cutouts in the field generating electrodes and protrusions on the field generating electrodes. As the cutouts and the protrusions can determine the tilt directions of the LC molecules, the tilt directions can be distributed into several directions by disposing the cutouts and the protrusions in various ways such that the reference viewing angle is widened.

An increase in the number of the cutouts and the protrusions reduces the transmittance more because it is hard for light to transmit where the cutouts or the protrusions are located. However, if the distances between protrusions or cutouts are widened to improve the transmittance, the benefits associated with the protrusions or cutouts are reduced and the response time may become longer owing to an increased disturbance of the electric field by the data lines.

Thus, there is a need for a liquid crystal display which provides improved response speed as well as improved transmittance.

### SUMMARY OF THE INVENTION

In accordance with an exemplary embodiment of the present invention, a liquid crystal display is provided. The liquid crystal display includes a transparent substrate, a transparent conductor formed on the transparent substrate, a gate line formed on the transparent conductor, a data line intersecting the gate line, a pixel electrode formed on a pixel area defined by the gate line and the data line. The pixel electrode includes a first sub-pixel electrode, a second sub-pixel electrode, and a third sub-pixel electrode. The liquid crystal display further includes a switching element electrically connected to the gate line, the data line, and the pixel electrode. The first sub-pixel electrode and the second sub-pixel electrode are electrically connected to each other, and the third sub-pixel electrode is isolated from the first and second sub-pixel electrodes.

Here, the second sub-pixel electrode may include the same material as the transparent conductor.

The second sub-pixel electrode may be disposed in a different layer from the first and third sub-pixel electrodes.

The second sub-pixel electrode may be disposed in the same layer as the transparent conductor.

The second sub-pixel electrode may overlap the third sub-pixel electrode.

The area of the second sub-pixel electrode or the third sub-pixel electrode may be about 0.2 to about 2 times the area of the first sub-pixel electrode. In accordance with an exemplary embodiment of the present invention, a liquid crystal display is provided. The liquid crystal includes a first display panel including first and second sub-pixel electrodes electrically connected to each other, a third sub-pixel electrode isolated from the first and second sub-pixel electrodes, and a first insulating layer covering the second sub-pixel electrode and not covering the first sub-pixel electrode. Moreover, the liquid crystal display further includes a second display panel opposing the first display panel and including a common electrode and a liquid crystal layer interposed between the first display panel and the second display panel.

Here, the first insulating layer may be disposed under the first and third sub-pixel electrodes.

The second sub-pixel electrode may overlap the third sub-pixel electrode.

The liquid crystal display may further include: a thin film transistor connected to the first sub-pixel electrode or the second sub-pixel electrode, a gate line connected to the thin film transistor, a data line connected to the thin film transistor and a second insulating layer formed between the gate line and the data line. The first insulating layer may be disposed over the thin film transistor, the gate line, and the data line.

The second sub-pixel electrode may be disposed over the second insulating layer.

The second sub-pixel electrode may be disposed under the second insulating layer.

The thickness of the first or the second insulating layer may range from about 200 nanometers (nm) to about 1000 nm.

The dielectric constant of the first or the second insulating layer may range from about 2 to about 8.

The area of the second sub-pixel electrode or the third sub-pixel electrode may be about 0.2 to about 2 times the area of the first sub-pixel electrode.

The second sub-pixel electrode may be made of the same material as the gate line or the data line.

The second sub-pixel electrode may be made of the same material as the first and third sub-pixel electrodes.

The liquid crystal display may further include a polarizer provided on at least one of the first and second display panels.

Each of the first and third sub-pixel electrodes may include at least one boundary that forms an oblique angle with respect to a polarization axis of the polarizer.

The oblique angle may be about 45 degrees.

The outer boundary of the first to third sub-pixel electrodes may be rectangular.

A pair of boundaries of the outer boundary of the first to third sub-pixel electrodes may be curved parallel to each other.

In accordance with an exemplary embodiment of the present invention, a liquid crystal display is provided. The liquid crystal display includes: a gate line, a data line intersecting the gate line, a switching element connected to the gate line and the data line, a first liquid crystal capacitor connected to the switching element, a first coupling capacitor connected to the switching element, a second liquid crystal capacitor connected to the first coupling capacitor, a second coupling capacitor connected to the switching element and a third liquid crystal capacitor connected to the second coupling capacitor.

Here, the distance between two terminals of the first liquid crystal capacitor may be different from the distance between two terminals of the second liquid crystal capacitor.

The voltage of the second or the third liquid crystal capacitor may be about 0.55 to about 0.85 times the voltage of the first liquid crystal capacitor. In accordance with an exemplary embodiment of the present invention, a liquid crystal display is provided. The liquid crystal display provides a liquid crystal display comprising: a first and a second sub-pixel electrode electrically connected to each other, and a third sub-pixel electrode separated from the first and the second sub-pixel electrodes. The third sub-pixel electrode together with the first and the second sub-pixel electrodes form a pixel electrode. The liquid crystal display further includes an insulating layer which covers the second sub-pixel electrode and does not cover the first sub-pixel electrode, a first switching element connected to the first sub-pixel electrode,

a second and a third switching element connected to the third sub-pixel electrode and a capacitor connected to the third switching element.

Here, the liquid crystal display may further comprise: a first gate line connected to the first and the second switching elements; a second gate line connected to the third switching element; and a data line connected to the first and the second switching elements.

The liquid crystal display may further comprise a storage electrode overlapping the pixel electrode.

The capacitor may include a drain electrode of the third switching element and the storage electrode as two terminals.

The thickness of the insulating layer may be about 200 nm to about 1,000 nm.

The dielectric constant of the insulating layer may be about 2 to about 8.

The area of the second sub-pixel electrode or the third sub-pixel electrode may be about 0.2 times to about twice the area of the first sub-pixel electrode.

The second sub-pixel electrode may be made of the same material as the first and the second gate lines or the data line.

The second sub-pixel electrode may be made of the same material as the first and the third sub-pixel electrodes.

Each of the first and the third sub-pixel electrodes may include at least one boundary which makes an oblique angle with respect to the first and the second gate lines.

The oblique angle may be about 45 degrees.

The outer boundary of the first to the third sub-pixel electrodes may be rectangular.

Each of the first to the third sub-pixel electrodes may include at least two parallelogrammic electrode pieces which have different inclination directions from each other.

### BRIEF DESCRIPTION OF THE DRAWINGS

FIG. 1 is a layout view of an LCD according to an exemplary embodiment of the present invention;

FIG. 2 and FIG. 3 are exemplary cross-sectional views of the LCD illustrated in FIG. 1 taken along the line II-II and the line III-III, respectively;

FIG. 4 is an exemplary cross-sectional view of the LCD illustrated in FIG. 1 taken along the line II-II;

FIG. 5A is an equivalent circuit diagram of a pixel of the LCD illustrated in FIG. 1 to FIG. 3;

FIG. 5B illustrates equipotential lines and an arrangement of liquid crystal molecules of the LCD illustrated in FIG. 1 to FIG. 4;

FIG. 6A to FIG. 6E are cross-sectional views illustrating the intermediate steps of a manufacturing method of the LCD illustrated in FIG. 4 according to an exemplary embodiment of the present invention;

FIG. 7 is an exemplary cross-sectional view of the LCD illustrated in FIG.1 taken along the line VII-VII;

FIG. 8 to FIG. 10 are layout views of an LCD according to an exemplary embodiment of the present invention;

FIG. 11A and FIG. 11B are drawings illustrating an electrode portion that is a fundamental unit of the respective sub-pixel electrodes of the LCD illustrated in FIG. 9 and FIG. 10;

FIG. 12 is a layout view of a liquid crystal panel assembly according to an exemplary embodiment of the present invention;

FIG. 13, FIG. 14, and FIG. 15 are cross-sectional views of the liquid crystal panel assembly illustrated in FIG. 12 taken along the line XIII-XIII, the line XIV-XIV, and the line XV-XV, respectively;

FIG. 16 is an equivalent circuit diagram of a pixel of the LCD illustrated in FIG. 12 to FIG. 15;

FIG. 17 is a layout view of a liquid crystal panel assembly according to an exemplary embodiment of the present invention; and

FIG. 18 is a cross-sectional view of the liquid crystal panel assembly illustrated in FIG. 17 taken along the line XVIII-XVIII.

### DETAILED DESCRIPTION OF THE EXEMPLARY EMBODIMENTS

Exemplary embodiments of the present invention will hereinafter be described in detail with reference to the accompanying drawings.

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

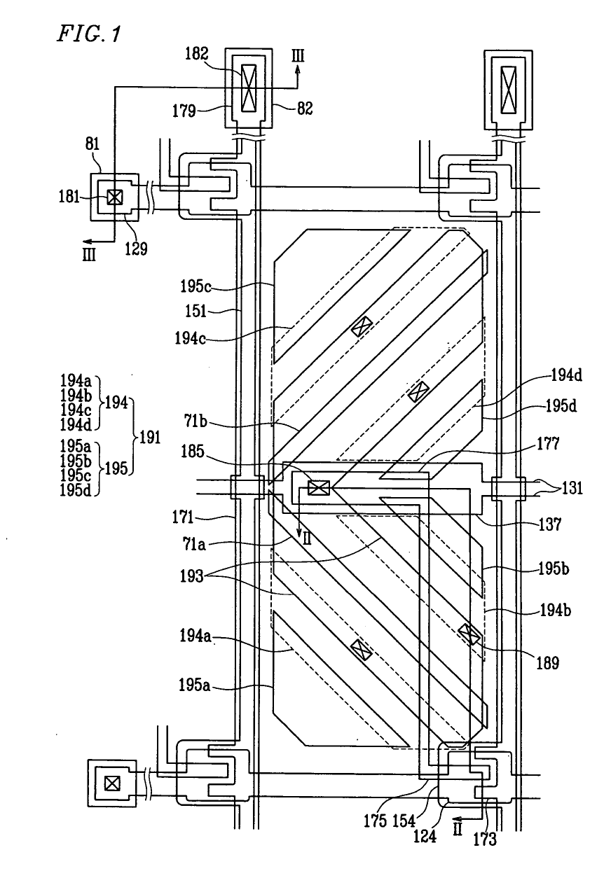

First, an LCD according to an exemplary embodiment of the present invention will be described in detail with reference to FIG. 1 to FIG. 3.

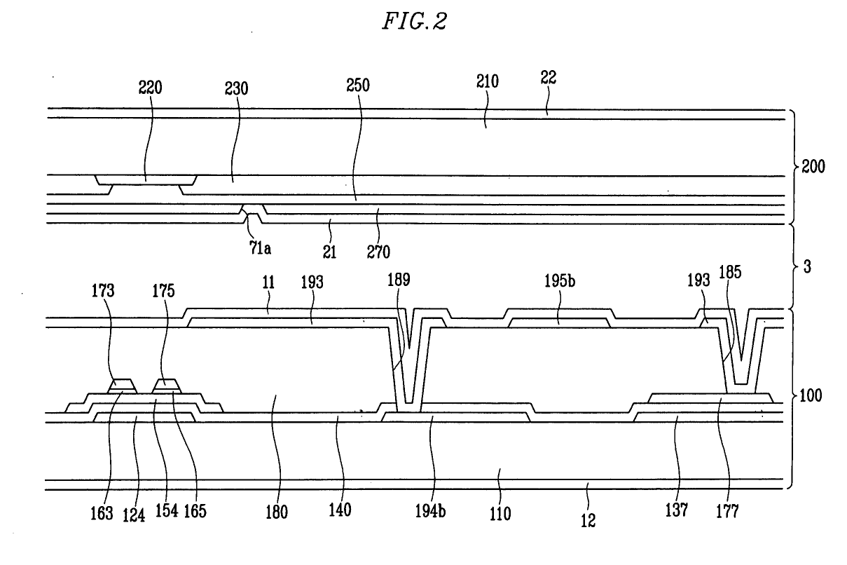

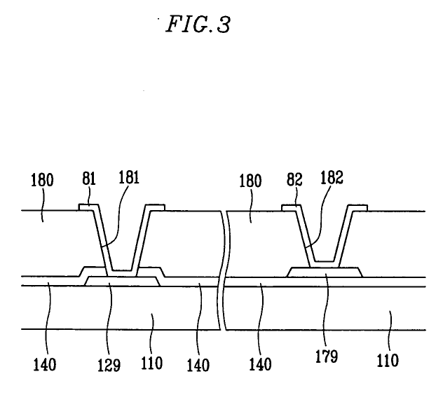

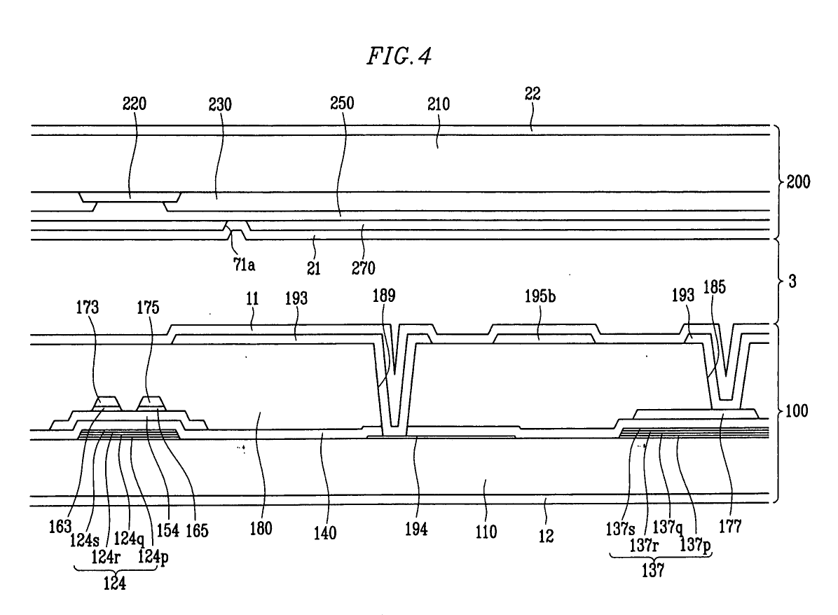

FIG. 1 is a layout view of an LCD according to an exemplary embodiment of the present invention, and FIG. 2 is an exemplary cross-sectional view of the LCD illustrated in FIG. 1 taken along the line II-II. FIG. 3 is an exemplary cross-sectional view of the LCD illustrated in FIG. 1 taken along the line III-III, and FIG. 4 is an exemplary cross-sectional view of the LCD illustrated in FIG. 1 taken along the line II-II.

Referring to FIG. 1 to FIG. 4, an LCD according to an exemplary embodiment of the present invention includes a thin film transistor array panel 100, a common electrode panel 200, and a liquid crystal layer 3 interposed between the two panels 100 and 200.

First, the TFT array panel 100 will be described in detail.

A plurality of gate lines 121, a plurality of storage electrode lines 131, and a plurality of lower sub-pixel electrodes 194 are formed on an insulating substrate 110 that is, for example, made of transparent glass or plastic.

The gate lines 121 for transmitting gate signals extend substantially in a transverse direction. Each of the gate lines 121 includes a plurality of gate electrodes 124 that protrude upward and downward and an end portion 129 having a large area for connection with another layer or a gate driver. A gate driving circuit for generating gate signals may be mounted on a flexible printed circuit film which is attached to the substrate 110, directly mounted on the substrate 110, or integrated into the substrate 110. When the gate driving circuit is integrated on the substrate 110, the gate lines 121 may be extended to be directly connected thereto.

The storage electrode lines 131 are supplied with a predetermined voltage and extend substantially parallel to the gate lines 121. Each of the storage electrode lines 131 is disposed between two adjacent gate lines 121 and is substantially equidistant from the two adjacent gate lines 121. Each storage electrode line 131 includes storage electrodes 137 extending upward and downward. However, the shapes and arrangements of the storage electrode lines 131 may be modified in various ways.

Each of the lower sub-pixel electrodes 194 comprises four strip-shaped lower electrode pieces 194a, 194b, 194c, and 194d, and each of the lower electrode pieces 194a-194d extends obliquely relative to the gate line 121, for example forming an angle of about 45 degrees with the gate line.

The gate lines 121 and the storage electrode lines 131 may be made of, for example, at least one of an aluminum-(Al) containing metal such as Al and an Al alloy, a silver-(Ag) containing metal such as Ag and a Ag alloy, a copper-(Cu) containing metal such as Cu and a Cu alloy, a molybdenum-(Mo) containing metal such as Mo and a Mo alloy, chromium (Cr), tantalum (Ta), and titanium (Ti). In FIG. 2 and FIG. 3, the gate lines 121 and the storage electrode. Lines 131 have a single-layered structure made of one material among the materials listed above.

However, the gate lines 121 and the storage electrode lines 131 may have a multi-layered structure including two conductive layers having different physical properties. One of the two conductive layers is made of, for example, a low resistivity metal such as an Al-containing metal, a Ag-containing metal, or a Cu-containing metal for reducing signal delay or voltage drop. On the other hand, for example, the other conductive layer is made of a material such as, a Mo-containing metal, Cr, Ti, and Ta, which has good physical, chemical, and electrical contact characteristics with other materials particularly such asindium tin oxide (ITO) or indium zinc oxide (IZO).

In FIG. 4, the gate lines 121 and the storage electrode lines 131 include four conductive layers. The lowest first conductive layer is made of a transparent material such as, for example, ITO or IZO, and the second conductive layer over the first conductive layer is made of a Mo-containing metal that has excellent contact characteristics with the first conductive layer. The third conductive layer over the second conductive layer is made of a material having low resistivity, and the fourth conductive layer over the third conductive layer may be made of the same material as the second conductive layer.

In FIG. 4, the lower sub-pixel electrode 194 is made of the same material as the first conductive layer 124p of the gate line 121, e.g. , a transparent material such as ITO or IZO, and it is simultaneously formed in the same layer as the first conductive layer 124p. In FIG. 4, as for the gate electrode 124 and the storage electrode 137, the English letter “p” for the first conductive layer, the English letter “q” for the second conductive layer, the English letter “r” for the third conductive layer, and the English letter “s” for the fourth conductive layer are affixed to the reference numerals representing the respective conductive layers.

However, the gate lines 121 and the storage electrode lines 131 may be made of many various metals or conductive materials besides the above.

The lower sub-pixel electrode 194a-194d may be made of the same material as the gate lines 121 and the storage electrode lines 131, or a transparent conductive material such as, for example, ITO or IZO. As for the example in FIG. 4, the lower sub-pixel electrode 194b may be made of a transparent material such as ITO or IZO.

The lateral sides of the gate lines 121 and the storage electrode lines 131 are inclined relative to a surface of the substrate 110, and the preferable inclination angle thereof ranges from about 30 degrees to about 80 degrees.

A gate insulating layer 140 made of, for example, silicon nitride (SiNx) or silicon oxide (SiOx) is formed on the gate lines 121, the storage electrode lines 131, and the lower sub-pixel electrodes 194a-194d.

A plurality of semiconductor stripes 151 made of, for example, hydrogenated amorphous silicon (abbreviated to “a-Si”) or polysilicon are formed on the gate insulating layer 140. Each semiconductor stripe 151 extends substantially in the longitudinal direction and has a plurality of projections 154 branched out toward the gate electrodes 124. The width of each semiconductor stripe 151 becomes large near the storage electrode lines 131 to cover large areas of the storage electrode lines 131.

A plurality of ohmic contact stripes and a plurality of ohmic contact islands 165 are formed on the semiconductor stripes 151. The ohmic contacts 165 are made of, for example, n+hydrogenated a-Si heavily doped with an n-type impurity such as phosphorus (P) or silicide. Each ohmic contact stripe has a plurality of projections 163, and the projections 163 and the ohmic contact islands 165 are disposed in pairs on the projections 154 of the semiconductor stripes 151.

The lateral sides of the semiconductors 154 and the ohmic contacts 163 and 165 are also inclined relative to a surface of the substrate 110, and the preferable inclination angle thereof ranges from about 30 degrees to about 80 degrees.

A plurality of data conductors including a plurality of data lines 171 and a plurality of drain electrodes 175 are formed on the ohmic contacts 163 and 165 and the gate insulating layer 140.

The data lines 171 for transmitting data signals extend substantially in the longitudinal direction and intersect the gate lines 121 and the storage electrode lines 131. Each data line 171 includes a plurality of source electrodes 173 that branch out toward the gate electrodes 124 to be curved in a shape of a letter “J” and an end portion 179 having a large area for connection with another layer or an external driving circuit. The data driving circuit for generating data voltages may be mounted on a flexible printed circuit film attached to the substrate 110, or it may be directly mounted on the substrate 110 or integrated on the substrate 110. When the data driving circuit is integrated on the substrate 110, the data lines 171 may be extended to be directly connected to the data driving circuit.

Each drain electrode 175 is separated from the data line 171 and opposes the source electrode 173 with respect to a gate electrode 124. Each drain electrode 175 has an end portion 177 having a large area and another stick-shaped end portion. The end portion 177 having a large area overlaps the storage electrode 137, and the stick-shaped end portion is partially surrounded by the source electrode 173.

A gate electrode 124, a source electrode 173, and a drain electrode 175, along with a projection 154 of a semiconductor stripe 151, form a thin film transistor (TFT) having a channel formed in the projection 154 disposed between the source electrode 173 and the drain electrode 175.

The data lines 171 and the drain electrodes 175 are made of a refractory metal such as, for example, Mo, Cr, Ta, and Ti, or an alloy thereof, and they may have a multi-layered structure including a refractory metal layer and a conductive layer having low resistivity. Examples of the multi-layered structure include but are not limited to a double-layered structure including a lower Cr or Mo (alloy) layer and an upper Al (alloy) layer, and a triple-layered structure including a lower Mo (alloy) layer, an intermediate Al (alloy) layer, and an upper Mo (alloy) layer. However, the data lines 171 and the drain electrodes 175 may be made of many various metals or conductive materials besides the above.

The lateral sides of the data conductors 171 and 175 are also inclined relative to a surface of the substrate 110, and the inclination angles thereof are, for example, in a range of about 30 degrees to about 80 degrees.

The ohmic contacts 163 and 165 are interposed only between the underlying semiconductors 154 and the overlying data conductors 171 and 175 thereon, and reduce the contact resistance there between. Most of each semiconductor stripe 151 is narrower than the data line 171, but as mentioned above, the width of the semiconductor stripe 151 broadens near a place where the semiconductor stripe 151 and the storage electrode line 131 meet each other to make the profile of the surface smooth and prevent disconnection of the data line 171. The semiconductor 154 includes exposed portions that are not covered with the data conductors 171 and 175 such as the portion located between the source electrode 173 and the drain electrode 175.

A passivation layer 180 is formed on the data conductors 171 and 175 and the exposed portions of the semiconductors 154. The passivation layer 180 is made of, for example, an inorganic insulator or an organic insulator, and the surface thereof may be flat. An example of the inorganic insulator includes silicon nitride and silicon oxide. The organic insulator may have photo sensitivity. However, the passivation layer 180 may have a double-layered structure including a lower inorganic layer and an upper organic layer so as not harm the exposed portions of the semiconductors 154 and to make the most of the improved insulating characteristics of an organic layer.

The dielectric constant of the passivation layer 180 and the gate insulating layer 140 may range from about 2 to about 8, and the thickness thereof may range from about 200 nanometers (nm) to about 1000nm.

The passivation layer 180 has a plurality of contact holes 182 exposing the end portions 179 of the data lines 171 and a plurality of contact holes 185 exposing the expansions 177 of the drain electrodes 175. The passivation layer 180 and the gate insulating layer 140 have a plurality of contact holes 181 exposing the end portions 129 of the gate lines 121 and a plurality of contact holes 189 exposing the lower sub-pixel electrodes 194a-194d.

A plurality of first upper sub-pixel electrodes 193, a plurality of second upper sub-pixel electrodes 195, and a plurality of contact assistants 81 and 82 are formed on the passivation layer 180. For example, these may be made of a transparent conductive material such as ITO and IZO, or a reflective metal such as Al, Ag, Cr, and alloys thereof.

Each of the second upper sub-pixel electrodes 195 comprises four strip-shaped upper electrode pieces 195a, 195b, 195c, and 195d, and the first upper sub-pixel electrode 193 and the second upper sub-pixel electrode 195, along with the lower sub-pixel electrode 194, constitute a pixel electrode 191.

The first upper sub-pixel electrode 193 is physically and electrically connected with the drain electrode 175 through the contact hole 185 and with the lower sub-pixel electrode 194 through the contact holes 189. Also, the lower sub-pixel electrode 194 and the second upper sub-pixel electrode 195 overlap each other to form a coupling capacitor.

The first upper sub-pixel electrode 193 is supplied with a data voltage from the drain electrode 175 and transmits the data voltage to the lower sub-pixel electrode 194, and the second upper sub-pixel electrode 195 is supplied with the voltage obtained by the capacitive coupling with the lower sub-pixel electrode 194.

The pixel electrode 191 comprising these sub-pixel electrodes 193, 194, and 195 generates an electric field in cooperation with the common electrode 270 on the common electrode panel 200 supplied with a common voltage so that the orientations of the liquid crystal molecules 31 in the liquid crystal layer 3 interposed between the two electrodes 191 and 270 are determined. In accordance with the determined orientations of the liquid crystal molecules 31, the polarization of light passing through the liquid crystal layer 3 is varied. A pixel electrode 191 and the common electrode 270 form a capacitor (hereinafter, referred to as a “liquid crystal capacitor”) to store and preserve the applied voltage even after the TFT is turned off.

The pixel electrode 191 and the end portion 177 of the drain electrode 175 connected to the pixel electrode 191 overlap the storage electrode line 131 including the storage electrode 137. The pixel electrode 191 and the drain electrode 175 connected electrically with the pixel electrode 191 overlap the storage electrode line 131 to form a capacitor referred to as a “storage capacitor”, which enhances the voltage storing capacity of the liquid crystal capacitor.

Each pixel electrode 191 has four major edges that are substantially parallel to the gate line 121 or the data line 171, and substantially has a shape of a quadrangle having four chamfered corners. The center portion of the right major edge of the pixel electrode 191 is cut in the shape of a funnel to form oblique edges, and the chambered corners of the pixel electrode 191 and the oblique edges form an angle of about 45 degrees with respect to the gate line 121. The pixel electrode 191 substantially has inversion symmetry with respect to the storage electrode lines 131.

The first upper sub-pixel electrode 193 and the upper electrode pieces 195a-195d have at least one primary edge that forms an oblique angle with the major edges of the pixel electrode 191, and the primary edge forms an angle of about 45 degrees with the polarization axes of the polarizers 12 and 22 so that the light efficiency of the LCD may be maximized.

The upper electrode pieces 195a-195d are disposed on both sides of the first upper sub-pixel electrode 193, and the opposing edges facing each other of the first upper sub-pixel electrode 193 and the upper electrode pieces 195a-195d are the primary edges and are substantially parallel to each other. The spaces between the first upper sub-pixel electrode 193 and the upper electrode pieces 195a-195d are occupied by the lower electrode pieces 194a-194d so that there is no opening.

The areas of the lower sub-pixel electrode 194 and the second upper sub-pixel electrode 195 are for example about 0.2 times to twice the area of the first upper sub-pixel electrode 193.

Cutouts extending substantially parallel to the primary edges of the first sub-pixel electrode 193 and the upper electrode pieces 195a-195d may be formed in the pixel electrode 191. These cutouts divide the sub-pixel electrodes 193,194, and 195 into a plurality of regions.

As mentioned above, the pixel electrode 191 is divided into a plurality of sub-pixel electrodes 193,194, and 195 and electrode pieces 194a-194d and 195a-195d, and the number of the sub-pixel electrodes may be varied depending on the design factors such as, for example, the size of the pixel electrode 191, the length ratio of the transverse edges and the longitudinal edges of the pixel electrode 191, and the type or the characteristics of the liquid crystal layer 3.

The contact assistants 81 and 82 are connected to the end portion 129 of the gate line 121 and the end portion 179 of the data line 171 through the contact holes 181 and 182, respectively. The contact assistants 81 and 82 supplement the adhesive property of the end portions 129 of the gate lines 121 and the end portions 179 of the data lines 171 to exterior devices, and protect them.

Next, a description of the upper panel 200 is given.

A light blocking member 220 is formed on an insulating substrate 210, made of, for example, transparent glass or plastic. The light blocking member 220 is also called a black matrix and it prevents light leakage.

A plurality of color filters 230 are also formed on the substrate 210 and the light blocking member 220. The color filters 230 are disposed substantially in the areas enclosed by the light blocking member 220 and may extend in a longitudinal direction substantially along the pixel electrodes 191. Each of the color filters 230 may represent one of the primary colors such as three primary colors of red, green, and blue.

An overcoat 250 is formed on the color filters 230 and the light blocking member 200. The overcoat 250 is made of, for example, an organic insulator, and it prevents the color filters 230 from being exposed and provides a flat surface. The overcoat 250 may be omitted.

A common electrode 270 is formed on the overcoat 250. The common electrode 270 is made of, for example, a transparent conductive material such as, for example, ITO and IZO, and has a plurality of sets of cutouts 71a and 71b.

One set of cutouts 71a and 71b opposes one pixel electrode 191 and includes a lower cutout 71a and an upper cutout 71b.

The lower and upper cutouts 71a and 71b extend substantially parallel to the primary edges of the first sub-pixel electrode 193 and the upper electrode pieces 195a-195d, and substantially from the right edge to the left edge of the pixel electrode 191. The cutouts 71a and 71b bisect the first upper sub-pixel electrode 193.

The number of cutouts 71a and 71b may also be varied depending on design factors, and the light blocking member 220 may overlap the cutouts 71a and 71b to block light leakage near the cutouts 71a and 71b.

Alignment layers 11 and 21 are coated on inner surfaces of the panels 100 and 200, and they may be vertical alignment layers. Polarizers 21 and 22 are provided on outer surfaces of the panels 100 and 200, and their polarization axes are perpendicular to each other and preferably form an angle of about 45 degrees with the primary edges of the first sub-pixel electrode 193 and the upper electrode pieces 195a-195d. One of the polarizers may be omitted when the LCD is a reflective LCD.

An LCD according to the present exemplary embodiment may further include a retardation film for compensating the retardation of the liquid crystal layer 3. The LCD may also include a backlight unit for providing light to the panels 100 and 200 and the liquid crystal layer 3.

The liquid crystal layer 3 is in a state of negative dielectric anisotropy, and the liquid crystal molecules 31 in the liquid crystal layer 3 are aligned such that their long axes are substantially vertical to the surfaces of the panels 100 and 200 in the absence of an electric field. Therefore, incident light directed into the liquid crystal layer 3 can't pass through the crossed polarizers 12 and 22 and is blocked.

On the other hand, as mentioned above, the first upper sub-pixel electrode 193 is applied with a data voltage from the drain electrode 175 and transmits the data voltage to the lower sub-pixel electrode 194.

The pixel electrode applied with a data voltage and the common electrode applied with a common voltage form a liquid crystal capacitor, thereby generating an electric field in the liquid crystal layer 3. Here, the voltage of the first upper sub-pixel electrode 193 is equal to the voltage of the lower sub-pixel electrode 194, but the strength of the electric field that the liquid crystal molecules over the lower sub-pixel electrode 194 are subject to is different from the strength of the electric field that the liquid crystal molecules over the first upper sub-pixel electrode 193 are subject to. This is because the distance between the lower sub-pixel electrode 194 and the common electrode 270 is different from the distance between the upper sub-pixel electrode 193 and the common electrode 270, and also because the dielectric constants of the gate insulating layer 140 and the passivation layer 180 located over the lower sub-pixel electrode 194 are different from the dielectric constant of the liquid crystal layer 3.

Therefore, a liquid crystal capacitor formed by a pixel electrode 191 and the common electrode 270 may be divided into a first liquid crystal capacitor including the liquid crystal layer 3 disposed between the first upper sub-pixel electrode 193 and the common electrode 270 as its dielectric, a first coupling capacitor including the gate insulating layer 140 and the passivation layer 180 disposed over the lower sub-pixel electrode 194 as its dielectric, a second liquid crystal capacitor including the liquid crystal layer 3 disposed over the lower sub-pixel electrode 194 as its dielectric, a second coupling capacitor including the gate insulating layer 140 and the passivation layer 180 disposed between the lower sub-pixel electrode 194 and the second upper sub-pixel electrode 195 as its dielectric, and a third liquid crystal capacitor including the liquid crystal layer 3 disposed between the first upper sub-pixel electrode 193 and the common electrode 270 as its dielectric.

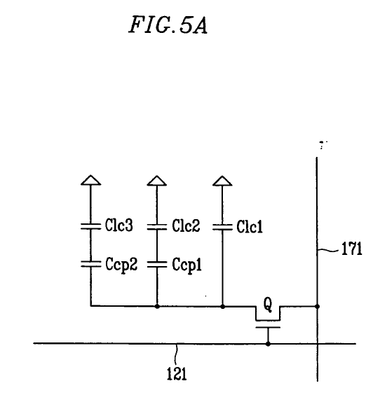

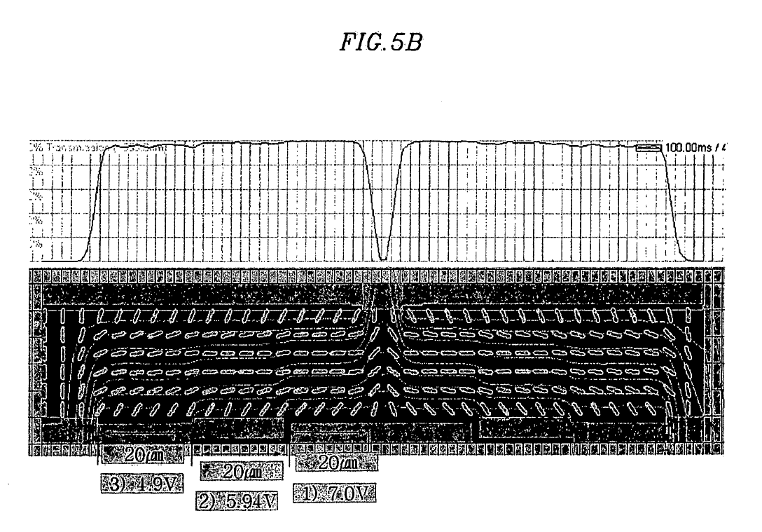

The above-described LCD may be represented in the equivalent circuit diagram of FIG. 5A.

Referring to FIG. 5A, a pixel of an LCD includes a TFT Q, a first liquid crystal capacitor Clc1, a second liquid crystal capacitor Clc2, a third liquid crystal capacitor Clc3, a first coupling capacitor Ccp1, and a second coupling capacitor Ccp2. In addition, each pixel further includes a storage capacitor.

The first liquid crystal capacitor Clc1 is connected to the drain of the TFT Q. The first coupling capacitor Ccp1 is connected between the TFT Q and the second liquid crystal capacitor Clc2, and the second coupling capacitor Ccp2 is connected between the TFT Q and the third liquid crystal capacitor Clc3. The common electrode 270 is applied with a common voltage Vcom.

The TFT Q applies a data voltage from the data line 171 to the first liquid crystal capacitor Clc1 and the first and second coupling capacitors Ccp1 and Ccp2 in response to a gate signal from the gate line 121, and then the first and second coupling capacitors Ccpl and Ccp2 modify the magnitude of the data voltage and transmit the data voltage to the second and third liquid crystal capacitors Clc2 and Ccl3, respectively.

If the capacitors Clc1, Clc2, Cic3, Ccp1, and Ccp2 and the capacitances thereof are denoted by the same reference numerals, the relationships between the voltage Va charged across the first liquid crystal capacitor Clc1, the voltage Vb charged across the second liquid crystal capacitor Clc2, and the voltage Vc charged across the third liquid crystal capacitor Clc3 are given as follows.
Vb=Va×[Ccp1/(Ccp1+Clc2)]
Vc=Va×[Ccp2/(Ccp2+Clc3)]

As the terms Ccp1/(Ccp1+Clc2) and Ccp2/(Ccp2+Clc3) are smaller than 1, the voltages Vb and Vc charged across the second and third liquid crystal capacitors Clc2 and Clc3 are always smaller than the voltage Va charged across the first liquid crystal capacitor Clc1. Also, the voltage Vb across the second liquid crystal capacitor Clc2 is different from the voltage Vc across the third liquid crystal capacitor Clc3.

In this way, when a potential difference is generated across the first to third liquid crystal capacitors Clc1, Clc2, and Clc3, an electric field that is substantially vertical to the surfaces of the panels 100 and 200 is generated in the liquid crystal layer 3. (Hereinafter, the pixel electrode 191 including the sub-pixel electrodes 193, 194, and 195 and the common electrode 270 are altogether referred to as “field generating electrodes”.) Then, the liquid crystal molecules in the liquid crystal layer 3 tilt in response to the electric field such that their long axes become perpendicular to the electric field direction, and the degree of the tilt of the liquid crystal molecules determines the change of the polarization of incident light into the liquid crystal layer 3. This change of light polarization causes a change of light transmittance through the polarizers, and in this way, the LCD displays images.

The tilt angle of the liquid crystal molecules depends on the strength of the electric field. As the voltage Va of the first liquid crystal capacitor Clc1, the voltage Vb of the second liquid crystal capacitor Clc2, and the voltage of the third liquid crystal capacitor Clc3 are different from each other, the tilt angles of the liquid crystal molecules in the respective liquid crystal capacitors Clc1, Clc2, and Cic3 are also different from each other, and accordingly the luminances of the respective liquid crystal capacitors Clc1, Clc2, and Clc3 are different from each other. Therefore, the voltage Va of the first liquid crystal capacitor Clc1, the voltage Vb of the second liquid crystal capacitor Clc2, and the voltage Vc of the third liquid crystal capacitor Clc3 can be adjusted so that an image viewed from a lateral side is most similar to an image viewed from the front, thereby improving the lateral visibility.

The appropriate ratio of the voltage Va of the first liquid crystal capacitor Clc1, the voltage Vb of the second liquid crystal capacitor Clc2, and the voltage Vc of the third liquid crystal capacitor Clc3 may be adjusted by varying the capacitances of the first and second coupling capacitors Ccp1 and Ccp2. The capacitance of the first coupling capacitor Ccp1 can be varied by adjusting the overlapped area of the lower sub-pixel electrode 194 and the common electrode 270 and the dielectric constant of the gate insulating layer 140 or the passivation layer 180 which functions as the dielectric. The capacitance of the second coupling capacitor Ccp2 can be varied by adjusting the overlapped area of the lower sub-pixel electrode 194 and the second upper sub-pixel electrode 195, and the distance there between.

The voltage Vb or Vc of the second or third liquid crystal capacitor Clc2 or Clc3 is, for example, about 0.55 to about 0.85 times the voltage Va of the first liquid crystal capacitor Clc1.

The edges of the sub-pixel electrodes 193, 194, and 195 and the cutouts 71a and 71b of the common electrode 270 distort the electric field to generate horizontal components of the electric field, which determines the tilt direction of the liquid crystal molecules, and the horizontal components of the electric field are perpendicular to the edges of the sub-pixel electrodes 193, 194, and 195 and the edges of the cutouts 71a and 71b.

Referring to FIG. 1, a set of the cutouts 71a and 71b divides a pixel electrode 191 into a plurality of sub-areas, each of which has two oblique major edges. As the liquid crystal molecules on each sub-area tilt vertically to the major edges, the azimuthal distribution of the tilt directions is localized to four directions. In this way, if tilt directions of the liquid crystal molecules are various, the reference viewing angle of the LCD is increased.

Each sub-area is divided into a plurality of small regions by the edges of the sub-pixel electrodes 193, 194, and 195 and the electrode pieces 194a-194d and 195a-195d, and as described above, the tilt angles of the liquid crystal molecules on the respective small regions are different from each other, thereby improving the visibility. Also, as the direction of the equipotential lines or the electric field around the boundaries of each small region is temporarily varied to generate horizontal components of the electric field, the response time of the liquid crystal is decreased.

Also, the transmittance is decreased as much as the area occupied by the cutouts in the prior LCDs including cutouts in the pixel electrode 191. However, in the LCD according to the present exemplary embodiment, the transmittance is significantly improved because of having very few cutouts. Moreover, even though cutouts are formed in the pixel electrode 191, the distance between cutouts can be sufficiently wide because horizontal components of the electric field are generated near the boundaries of each small region, that is, the boundaries of the first sub-pixel electrode 193 and the upper electrode pieces 195a-195d.

The shape and configuration of the sub-pixel electrodes 193, 194, and 195 and the cutouts 71a and 71b may be variously modified, and at least one of the cutouts 71a and 71b may be substituted with protrusions , depressions, or slope members. The protrusions or the slope members may be made of an organic material or an inorganic material, and be disposed on or under the field generating electrodes 191 and 270.

Equipotential lines and the arrangement of the liquid crystal molecules in the above-described LCD will now be described in detail referring to FIG. 5B.

FIG. 5B illustrates equipotential lines and an arrangement of liquid crystal molecules of the LCD illustrated in FIG. 1 to FIG. 4.

In FIG. 5B, the width of each small region divided by the edges of the first and second upper sub-pixel electrodes 193 and 195a-195d was about 20μm, the voltage applied across the liquid crystal layer 3 over the first upper sub-pixel electrode 193 was about 7.0V, the voltage applied across the liquid crystal layer 3 over the second upper sub-pixel electrode 195 was about 4.9V, and the voltage applied across the liquid crystal layer 3 over the lower sub-pixel electrode 194 was about 5.94V.

As shown in FIG. 5B, the equipotential lines at the boundaries of the sub-pixel electrodes 193 and 195a-195d vary suddenly. Accordingly, the liquid crystal molecules form oblique angles with the equipotential lines, and the liquid crystal molecules move in a direction to form an acute angle, thereby increasing the response speed.

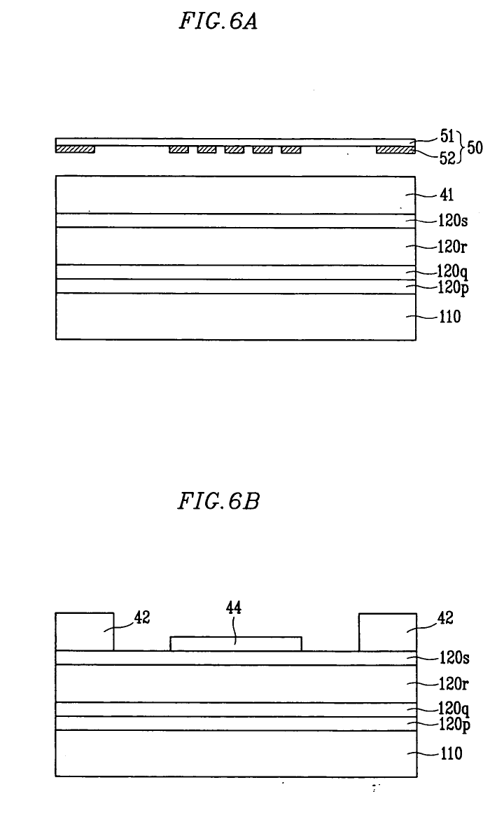

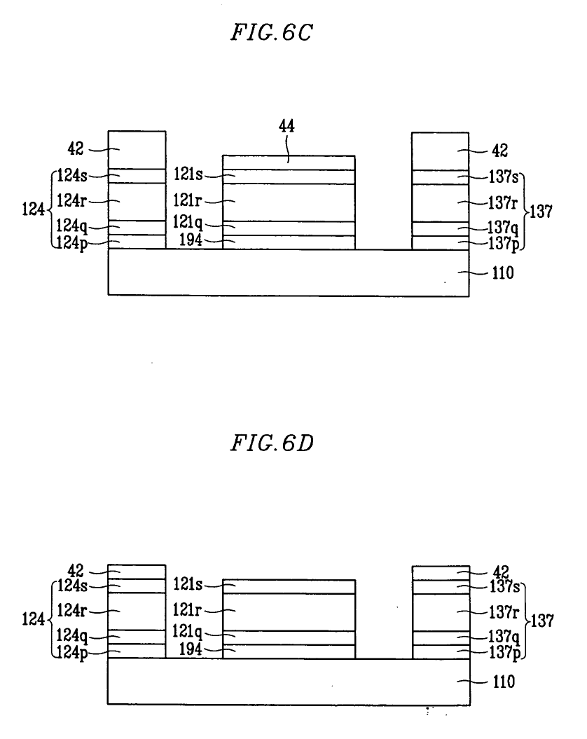

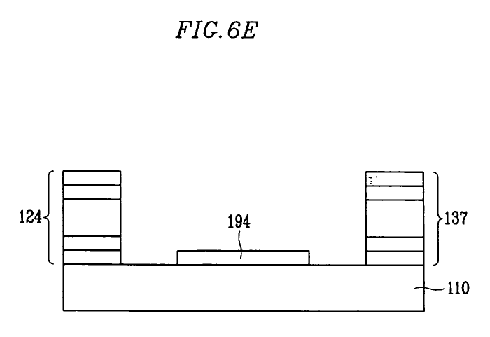

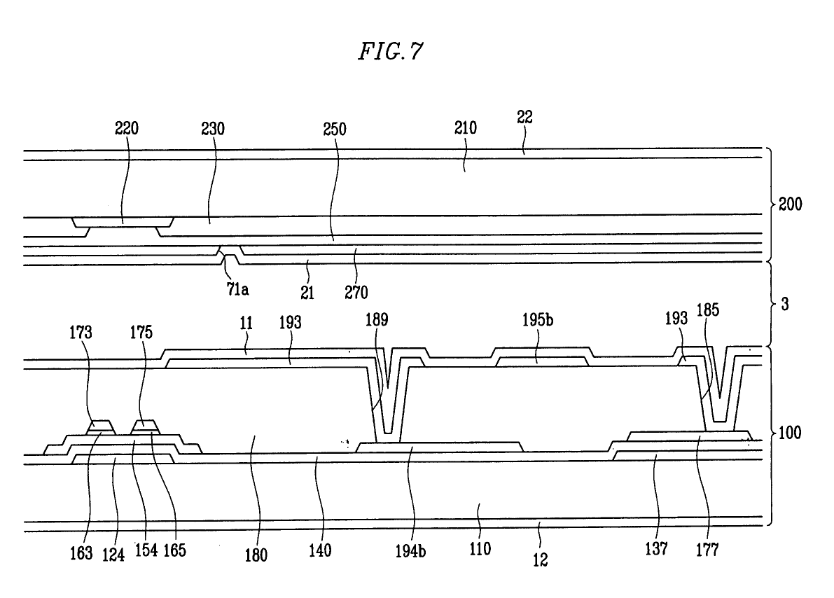

A method of forming the lower sub-pixel electrode in the LCD illustrated in FIG. 4 will now be described in detail referring to FIG. 6A to FIG. 6E.

FIG. 6A to FIG. 6E are cross-sectional views illustrating the intermediate steps of a manufacturing method of the LCD illustrated in FIG. 4 according to an exemplary embodiment of the present invention.

Referring to FIG. 6A, a first conductive layer 120p is deposited to be formed on a substrate 110 by sputtering ITO or IZO. Second, third, and fourth conductive layers 120q, 120r, and 120s are sequentially deposited to be formed on the first conductive layer 120p, for example by sputtering metals, and a photosensitive film 41 is coated on the fourth thin film 120s.

A photo-mask 50 including a substrate 51 and light blocking films 52 is arranged on the substrate 51 above the substrate 110. The photo-mask 50 is divided into light transmitting regions, translucent regions, and light blocking regions according to the existing pattern of the light blocking films 52. The light blocking regions are where the width of the light blocking film 52 is larger than a predetermined value, the light transmitting regions are where there is no light blocking film 52 over a predetermined width, and the translucent regions are where the width of the light blocking film 52 and the distance between the light blocking films 52 are smaller than predetermined values.

When the photosensitive film 40 is exposed to light through this photo-mask 50 , an etching mask 52 and 52 having a position-dependent thickness is formed as illustrated in FIG. 6B. In FIG. 6B, the thick region is denoted by the reference numeral 42, and the thin region is denoted by the reference numeral 44.

Referring to FIG. 6C, the exposed portions of the first to fourth conductive layers 120p-120s that are not covered with the etching mask 42 and 44 are removed to form a gate electrode 124, a storage electrode 137, and a lower sub-pixel electrode 194, as well as overlying first to third conductors 121q-121r.

Referring to FIG. 6D, the thickness of the etching mask 42 and 44 is decreased until the thin region 44 is removed by a procedure such as ashing.

Referring to FIG. 6E, the first to third conductors 120q-120s that are not covered with the etching mask 42 are removed so that only the lower sub-pixel electrode 194 remains. Finally, the residual etching mask 42 is removed.

Meanwhile, unlike FIG. 6A to FIG. 6E, the lower sub-pixel electrode 194 may be formed through one more process after forming the gate lines 121 including the gate electrodes 124 and the storage electrode lines 131 including the storage electrodes 137.

Now, an LCD according to another exemplary embodiment of the present invention will be described in detail with reference to FIG. 7.

FIG. 7 is another exemplary cross-sectional view of the LCD illustrated in FIG.1 taken along the line VII-VII.

As illustrated in FIG. 1 and FIG. 7, an LCD according to the present exemplary embodiment includes a TFT array panel 100, a common electrode panel 200, a liquid crystal layer 3 interposed between the two panels 100 and 200, and polarizers 11 and 21 attached to outer surfaces of the two panels 100 and 200.

The layered structure of the panels 100 and 200 according to the present exemplary embodiment is mostly similar to the layered structure of the LCD illustrated in FIG. 1 to FIG. 3.

The description of the TFT array panel 100 is as follows. A plurality of gate lines 121 and a plurality of storage electrode lines 131 are formed on a substrate 110. The gate line 121 includes a plurality of gate electrodes 124 and end portions 129, and the storage electrode line 121 includes storage electrodes 137 extending upward and downward. A gate insulating layer 140, a plurality of semiconductor stripes 151 having projections 154, a plurality of ohmic contact stripes having projections 163, and a plurality of ohmic contact islands 165 are sequentially formed on the gate lines 121 and the storage electrode lines 131. A plurality of data lines 171 including source electrodes 173 and end portions 179 are formed on the ohmic contacts 163 and 165 and the gate insulating layer 140, and a passivation layer 180 is formed thereon. A plurality of contact holes 181, 182, and 185 are formed on the passivation layer 180 and the gate insulating layer 140. First and second upper sub-pixel electrodes 193 and 195 and a plurality of contact assistants 81 and 82 are formed on the passivation layer 180, and an alignment layer 11 is formed thereon.

A description of the common electrode panel 200 is as follows. A light blocking member 220, color filters 230, an overcoat 250, a common electrode 270 having cutouts 71a and 71b, and an alignment layer 21 are sequentially formed on an insulating substrate 210.

However, unlike the LCD illustrated in FIG. 1 to FIG. 3, in the LCD according to the present exemplary embodiment, the lower sub-pixel electrodes 194 are disposed between the gate insulating layer 140 and the passivation layer 180 rather than under the gate insulating layer 140. The lower sub-pixel electrode 194 may be made of the same material as the data conductors 171 and 175.

Numerous characteristics of the LCD illustrated in FIG. 1 to FIG. 3 may also be applied to the LCD illustrated in FIG. 7.

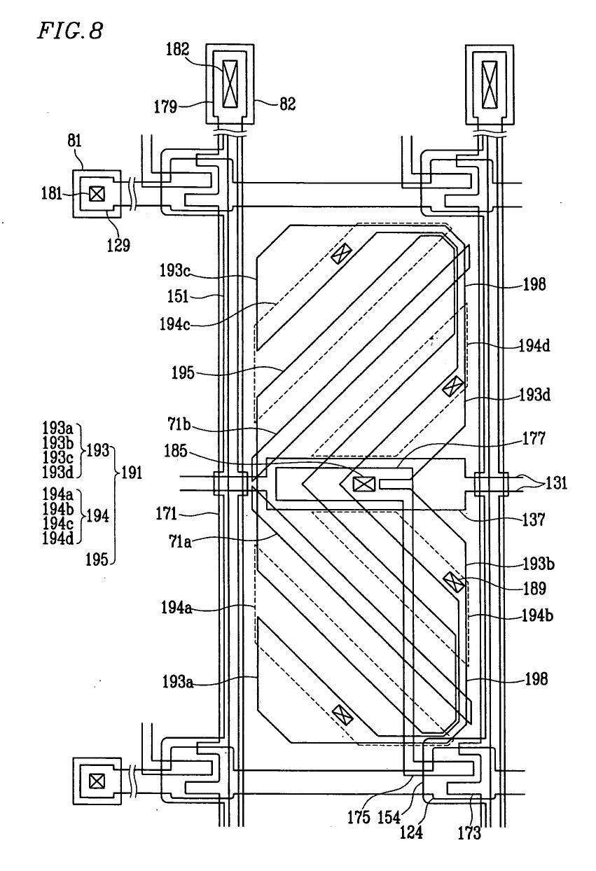

Next, FIG. 8 is a layout view of an LCD according to another exemplary embodiment of the present invention.

The layered structure of the LCD illustrated in FIG. 8 is not separately illustrated because it is similar to the layered structure illustrated in FIG. 2 and FIG. 3, and the following description will be given using the same reference numerals as those illustrated in FIG. 2 and FIG. 3.

The LCD illustrated in FIG. 8 also includes a TFT array panel 100, a common electrode panel 200, a liquid crystal layer 3 between the two panels 100 and 200, and polarizers 11 and 21 on outer surfaces of the two panels 100 and 200.

The description of the TFT array panel 100 is as follows. A plurality of gate lines 121 and a plurality of storage electrode lines 131 are formed on a substrate 110. The gate line 121 includes a plurality of gate electrodes 124 and end portions 129, and the storage electrode line 121 includes a plurality of storage electrodes 137. A gate insulating layer 140, semiconductor stripes 151 including projections 154, a plurality of ohmic contact stripes 161 having projections 163, and a plurality of ohmic contact islands 165 are sequentially formed on the gate lines 121 and the storage electrodelines 131. A plurality of data lines 171 including source electrodes 173 and end portions 179 are formed on the ohmic contacts 163 and 165 and the gate insulating layer 140, and a passivation layer 180 is formed thereon. A plurality of contact holes 181, 182, and 185 are formed on the passivation layer 180 and the gate insulating layer 140. A plurality of first and second upper sub-pixel electrodes 193 and 195 and a plurality of contact assistants 81 and 82 are formed on the passivation layer 180, and a plurality of lower sub-pixel electrodes 194 are formed under the passivation layer 180. An alignment layer 11 is formed on the upper sub-pixel electrodes 193 and 195, the contact assistants 81 and 82, and the passivation layer 180.

A description of the common electrode panel 200 is as follows. A light blocking member 220, a common electrode 270 having cutouts 71a and 71b, and an alignment layer 21 are sequentially formed on an insulating substrate 210.

However, unlike the LCD illustrated in FIG. 1 to FIG. 3, in the LCD according to the present exemplary embodiment, the disposition of the first upper sub-pixel electrode 193 and the second upper sub-pixel electrode 195 is reversed. Accordingly, the first upper sub-pixel electrode 193 is divided into four electrode pieces 193a, 193b, 193c, and 193d, and the second upper sub-pixel electrode 195 is made up of one piece. The first upper sub-pixel electrode 193 further includes connectors 198 connecting the electrode pieces 193a-193d.

Also, the cutouts 71a and 71b provided in the common electrode 270 bisect the second upper sub-pixel electrode 195 instead of the first upper sub-pixel electrode 193.

Numerous characteristics of the LCD illustrated in FIG. 1 to FIG. 3 may also be applied to the LCD illustrated in FIG. 8.

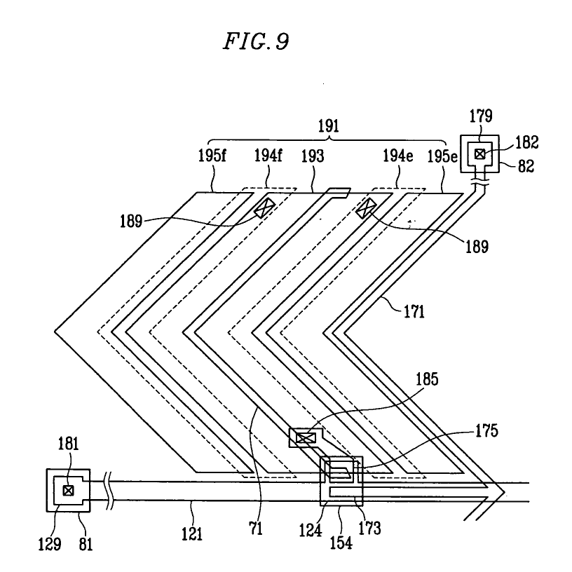

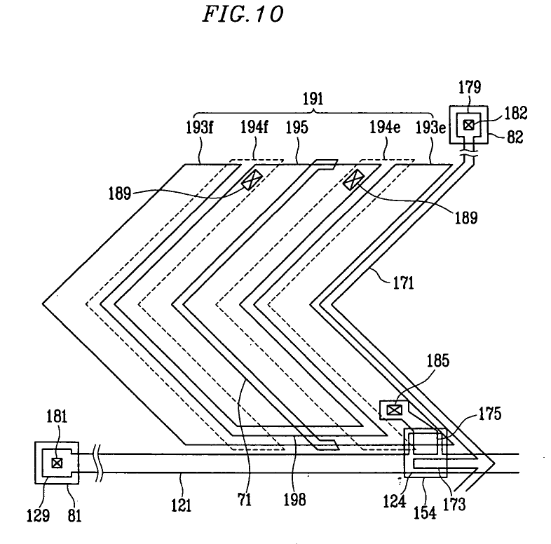

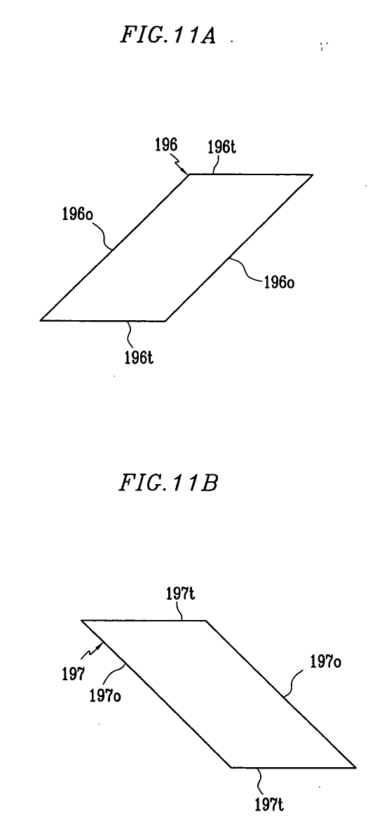

FIG. 9 and FIG. 10 are layout views of an LCD according to another exemplary embodiment of the present invention, and FIG. 11A and FIG. 11B are top plane views of an electrode portion that is a fundamental unit of the respective sub-pixel electrodes of the LCD illustrated in FIG. 9 and FIG. 10.

The layered structure of a liquid crystal panel assembly according to the present exemplary embodiment is not separately illustrated because it is mostly the same as the layered structure of the liquid crystal panel assembly illustrated in FIG. 2 and FIG. 3, and the following description will be given in comparison with FIG. 1 using the same reference numerals as those illustrated in FIG. 2 and FIG. 3.

The LCD illustrated in FIG. 9 and FIG. 10 also includes a TFT array panel 100, a common electrode panel 200, a liquid crystal layer 3 interposed between the two panels 100 and 200, and polarizers 11 and 21 attached on outer surfaces of the two panels 100 and 200.

The description of the lower panel 100 is as follows. A plurality of gate lines 121 are formed on an insulating substrate 100. Each gate line 121 includes gate electrodes 124 and an end portion 129. A gate insulating layer 140 is formed on the gate lines 121. A plurality of semiconductors 154 are formed on the gate insulating layer 140, and a plurality of ohmic contacts 163 and 165 are formed thereon. Data conductors including a plurality of data lines 171 and drain electrodes 175 are formed on the ohmic contacts 163 and 165 and the gate insulating layer 140. Each data line 171 includes source electrodes 173 and an end portion 179. A passivation layer 180 is formed on the data conductors 171 and 175 and the exposed portions of the semiconductors 154, and a plurality of contact holes 181, 182, and 185 are formed on the passivation layer 180 and the gate insulating layer 140. A plurality of first and second upper sub-pixel electrodes 193 and 195 and a plurality of contact assistants 81 and 82 are formed on the passivation layer 180, and a plurality of lower sub-pixel electrodes 194 are formed under the passivation layer 180. An alignment layer 11 is formed on the upper sub-pixel electrodes 193 and 195, the contact assistants 81 and 82, and the passivation layer 180.

A description of the common electrode panel 200 is as follows. A light blocking member 220, a common electrode 270 having cutouts 71, and an alignment layer 21 are sequentially formed on an insulating substrate 210.

The first and second upper sub-pixel electrodes 193 and 195 and the lower sub-pixel electrode 194 constitute a pixel electrode 191. The lower sub-pixel electrode 194 comprises a plurality of lower electrode pieces 194e and 194f, and the first/second upper sub-pixel electrode 193/195 comprises a plurality of electrode pieces 193e and 193f/195e and 195f, respectively.

However, unlike the LCD illustrated in FIG. 1, in the LCD according to the present exemplary embodiment, the pixel electrode 191 has a pair of curved edges that are parallel to each other. Similarly to this, each of the electrode pieces 193e, 193f, 194e, 194f, 195e, and 195f and the first upper sub-pixel electrode 193 also has a pair of curved edges that are parallel to each other. Also, each of the electrode pieces 193e, 193f, 194e, 194f, 195e, and 195f and the first upper sub-pixel electrode 193 includes at least one parallelogrammic electrode portion 196 illustrated in FIG. 11A and one parallelogrammic electrode portion 197 illustrated in FIG. 11 B.

As illustrated in FIG. 11A and FIG. 11B, each of the electrode pieces 196 and 197 has a pair of oblique edges 196o and 197o and a pair of transverse edges 196t and 197t and has substantially the same shape as a parallelogram. Each oblique edge 196o and 197o forms an oblique angle with the transverse edges 196t and 197t, and for example oblique angles range from about 45 degrees to about 135 degrees. Hereinafter, for convenience sake, the shape of the electrode pieces 196 and 197 is classified according to the direction of inclination (“inclination direction”) from a vertical state with respect to the transverse edges 196t and 197t, and it is referred to as “right inclination” when the inclination direction is rightward as shown in FIG. 1OA and as “left inclination” when the inclination direction is leftward.

Each of the electrode pieces 193e, 193f, 194e, 194f, 195e, and 195fand the first upper sub-pixel electrode 193 is formed by connecting the left inclination electrode portion 197 and the right inclination electrode portion 196 in the longitudinal direction.

In FIG. 9, the first upper sub-pixel electrode 193 is located in the middle of the pixel electrode 191, and the second upper sub-pixel electrode 195 comprises two electrode pieces 195e and 195f. On the other hand, in FIG.10, the second upper sub-pixel electrode 195 is located in the middle of the pixel electrode 191, and the first upper sub-pixel electrode 193 comprises two electrode pieces 193e and 193f, which are connected via a connector 198.

The cutout 71 of the common electrode 270 is substantially parallel to the curved edges of the pixel electrode 191, and the cutout 71 includes oblique portions bisecting the pixel electrode 191 and the first/second upper sub-pixel electrode (193/195) and transverse portions that make obtuse angles with respect to the oblique portions and overlap the transverse edges of the pixel electrode 191.

Meanwhile, in the structure illustrated in FIG. 9 and FIG. 10, the direction of a secondary electric field due to the voltage difference between the pixel electrodes 191 coincides with the direction of the horizontal component of the primary electric field generated at the boundaries of the upper sub-pixel electrodes 193 and 195 and at the boundaries of the cutout 71. Consequently, the secondary electric field between the pixel electrodes 191 enhances the determination of the tilt directions of the liquid crystal molecules.

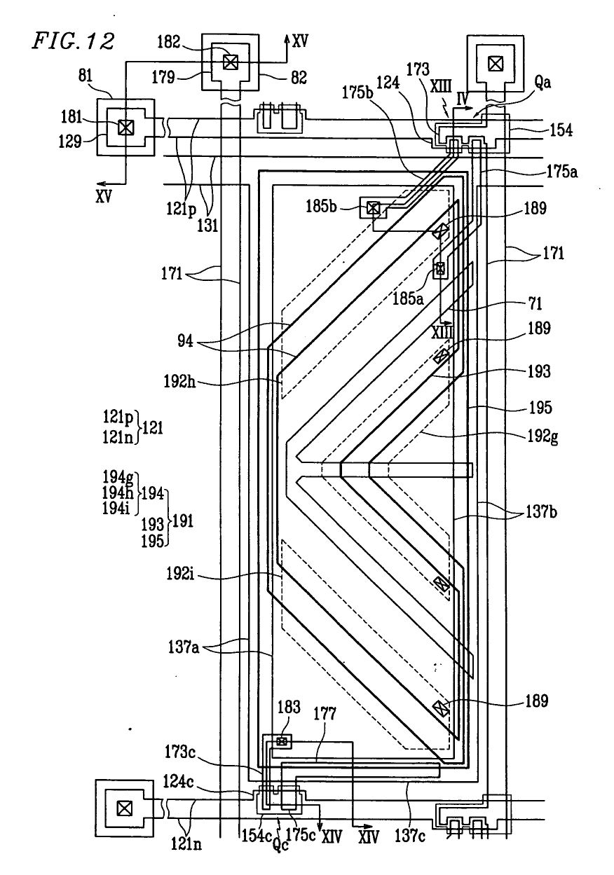

A liquid crystal panel assembly according to an exemplary embodiment of the present invention will be described in detail with reference to FIG. 12 to FIG. 15.

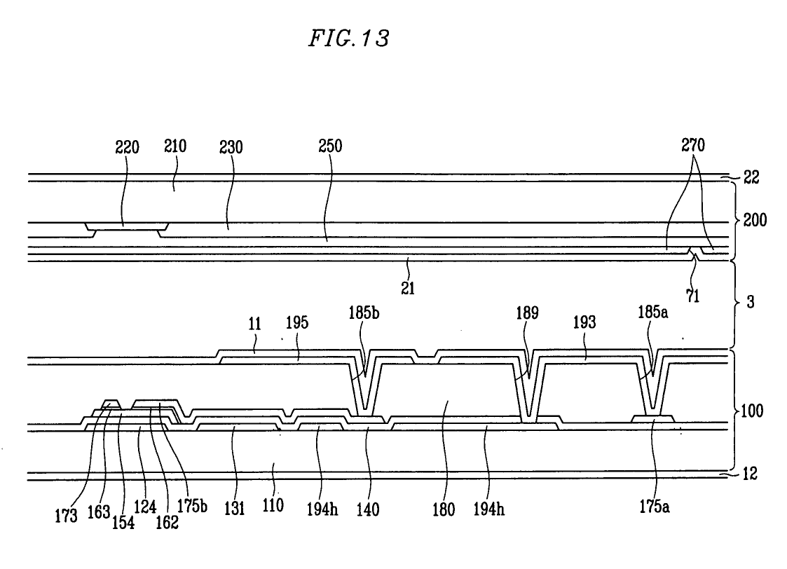

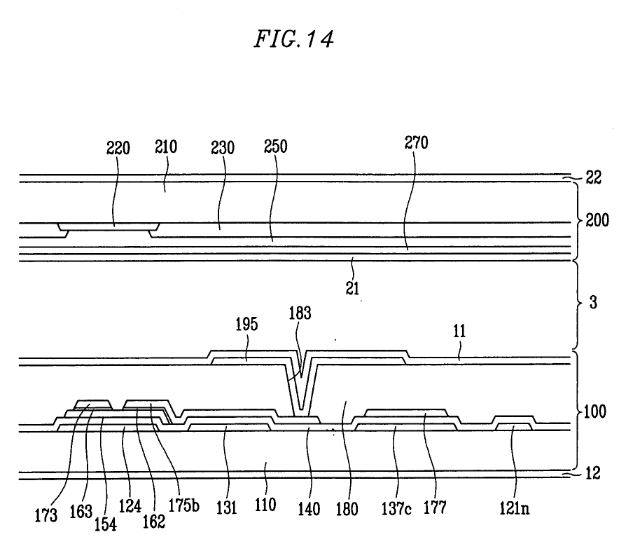

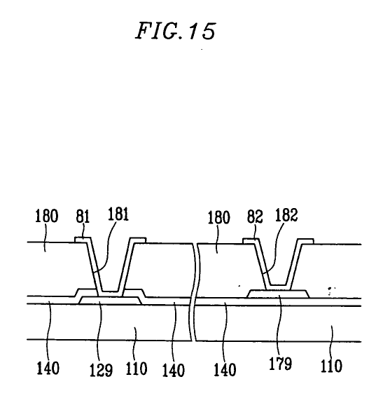

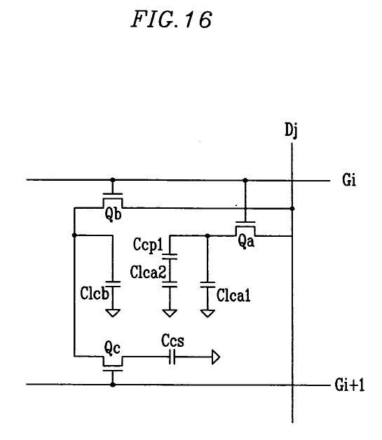

FIG. 12 is a layout view of a liquid crystal panel assembly according to an exemplary embodiment of the present invention, and FIG. 13, FIG. 14, and FIG. 15 are cross-sectional views of the liquid crystal panel assembly illustrated in FIG. 12 taken along the line XIII-XIII, the line XIV-XIV, and the line XV-XV, respectively.

Referring to FIG. 12 to FIG. 15, the LCD according to an exemplary embodiment of the present invention includes a TFT array panel 100, a common electrode panel 200, and a liquid crystal layer 3 interposed between the TFT array panel 100 and the common electrode panel 200. First, the TFT array panel 100 will be described in detail.

A plurality of gate lines 121, a plurality of storage electrode lines 131, and a plurality of lower sub-pixel electrodes 194 are formed on an insulating substrate 110 made of, for example, transparent glass or plastic.

The gate lines 121 for transmitting gate signals extend substantially in a transverse direction. Each of the gate lines 121 includes an upper gate line 121p and a lower gate line 121n which are adjacent to each other. Each of the gate lines 121 includes a plurality of first gate electrodes 124 protruding downward, a plurality of second gate electrodes 124c protruding upward, and an end portion 129 having a large area for connection with another layer or a gate driver. A gate driving circuit for generating gate signals may be mounted on a flexible printed circuit film which is attached to the substrate 110, or it may be directly mounted on the substrate 110, or it may be integrated onto the substrate 110. When the gate driving circuit is integrated on the substrate 110, the gate lines 121 may be extended to be directly connected thereto.

Each of the storage electrode lines 131 includes a stem line which supplied with a predetermined voltage and extending substantially parallel to the gate line 121, a first and a second storage electrodes 137a and 137b branched out from the stem, and a third storage electrode 137c connecting the first and the second storage electrodes 137a and 137b. Each of the storage electrode lines 131 is disposed between two adjacent gate lines 121. However, the shapes and arrangements of the storage electrode lines 131 may be modified in various ways.

Each of the lower sub-pixel electrodes 194 comprises a first, a second, and a third lower electrode pieces 194g, 194h, and 194i, and each of the lower electrode pieces 194g-194i extends obliquely relative to a gate line 121, for example, making an angle of about 45 degrees with the gate line.

A gate insulating layer 140 made of, for example, silicon nitride (SiNx) or silicon oxide (SiOx) is formed on the gate lines 121, the storage electrode lines 131, and the lower sub-pixel electrodes 194.

A plurality of first semiconductor islands 154 and second semiconductor islands 154c made of, for example, hydrogenated amorphous silicon (abbreviated to “a-Si”) or polysilicon are formed on the gate insulating layer 140.

A plurality of first to fourth ohmic contact islands 163, 165, 163c, and 165c are formed on the semiconductors 154 and 154c. The ohmic contacts 163,165, 163c, and 165c are preferably made of n+hydrogenated a-Si heavily doped with an n-type impurity such as phosphorus (P) or silicide. The first and the second ohmic contact islands 163 and 165 and the third and the fourth ohmic contact islands 163c and 165c are disposed in pairs on the first semiconductor islands 154 and the second semiconductor islands 154c, respectively.

A plurality of data conductors including a plurality of data lines 171, a plurality of first, second, and third drain electrodes 175a, 175b, and 175c, and source conductors 173c are formed on the ohmic contacts 163,165, 163c, and 165c and the gate insulating layer 140.

The data lines 171 for transmitting data signals extend substantially in the longitudinal direction and intersect the gate lines 121 and the storage electrode lines 131. Each data line 171 includes a plurality of source electrodes 173 which branch out toward the first gate electrodes 124 to be curved and an end portion 179 having a large area for connection with another layer or an external driving circuit. A data driving circuit for generating data voltages may be mounted on a flexible printed circuit film attached to the substrate 110, or it may be directly mounted on the substrate 110, or it may be integrated on the substrate 110. When the data driving circuit is integrated onto the substrate 110, the data lines 171 may extend to be directly connected to the data driving circuit.

The first to the third drain electrodes 175a, 175b, and 175c are separated from the data lines 171. Each of the first and the second drain electrodes 175a and 175b opposes the source electrode 173 with respect to the first gate electrode 124. Each of the first and the second drain electrodes 175a and 175b has a stick-shaped end portion disposed on the semiconductor 154, and the stick-shaped end portion is partially surrounded by a source electrode 173 curved in the shape of a letter “U”.

The source conductors 173c and the third drain electrodes 175c are separated from the data lines 171. Each of the source conductors 173c opposes the third drain electrode 175c with respect to the second gate electrode 124c.

Each of the third drain electrodes 175c has an end portion 177 having a large area and another end portion opposing the source conductor 173c.

A first gate electrode 124, a source electrode 173, and a first/second drain electrode 175a/175b, along with a semiconductor 154, form a first /second TFT Qa/Qb having a channel formed in the semiconductor 154 disposed between the source electrode 173 and the first/the second drain electrode 175a/175b.

A second gate electrode 124c, a source conductor 173c, and a third drain electrode 175c, along with a semiconductor 154c, form a third TFT Qc having a channel formed in the semiconductor 154c disposed between the source conductor 173c and the third drain electrode 175c.

A passivation layer 180 is formed on the data conductors 171, 173c, and 175a-c and the exposed portions of the semiconductors 154 and 154c.

The passivation layer 180 has a plurality of contact holes 182 exposing the end portions 179 of the data lines 171, a plurality of contact holes 185a exposing portions of the first drain electrodes 175a, a plurality of contact holes 185b exposing portions of the second drain electrodes 175b, and a plurality of contact holes 183 exposing portions of the source conductors 173c. The passivation layer 180 and the gate insulating layer 140 have a plurality of contact holes 181 exposing the end portions 129 of the gate lines 121 and a plurality of contact holes 189 exposing the lower sub-pixel electrodes 194g-i.

A plurality of first upper sub-pixel electrodes 193, a plurality of second upper sub-pixel electrodes 195, and a plurality of contact assistants 81 and 82 are formed on the passivation layer 180.

One pair of the first and the second upper sub-pixel electrodes 193 and 195 engage with each other having a gap 94 interposed there between, and the first upper sub-pixel electrode 193 is inserted in the middle of the second upper sub-pixel electrode 195. The first upper sub-pixel electrode 193 and the second upper sub-pixel electrode 195, along with the lower sub-pixel electrode 194, form a pixel electrode 191.

The areas of the lower sub-pixel electrode 194 and the second upper sub-pixel electrode 195 are, for example, about 0.2 times to about twice the area of the first upper sub-pixel electrode 193.

As mentioned above, the pixel electrode 191 is divided into a plurality of sub-pixel electrodes 193, 194, and 195, but the number of the sub-pixel electrodes may be varied depending on the design factors such as, for example, the size of the pixel electrode 191, the length ratio of the transverse edges and the longitudinal edges of the pixel electrode 191, and the type or the characteristics of the liquid crystal layer 3.

The first upper sub-pixel electrode 193 is physically and electrically connected with the first drain electrode 175a through the contact hole 185a and with the lower sub-pixel electrode 194 through the contact holes 189.

The second upper sub-pixel electrode 195 is physically and electrically connected with the second drain electrode 175b through the contact hole 185b and with the source conductor 173c through the contact hole 183.

The first upper sub-pixel electrode 193 is applied with a data voltage from the first drain electrode 175a and transmits the data voltage to the lower sub-pixel electrode 194. The second upper sub-pixel electrode 195 is applied with a data voltage from the second drain electrode 175b.

A third storage electrode 137c overlaps an end portion 177 having a large area of a third drain electrode 175c to form a capacitor, which is called a voltage drop capacitor. Charges are stored in the voltage drop capacitor through the third TFT Qc, thereby maintaining a lower voltage of the second upper sub-pixel electrode 195 than the applied data voltage.

The contact assistants 81 and 82 are connected to the end portion 129 of the gate line 121 and the end portion 179 of the data line 171 through the contact holes 181 and 182, respectively. The contact assistants 81 and 82 supplement the adhesive property of the end portions 129 of the gate lines 121 and the end portions 179 of the data lines 171 to exterior devices and protect them.

Next, the description of the upper panel 200 follows.

A light blocking member 220 is formed on an insulating substrate 210 made of, for example, transparent glass or plastic. A plurality of color filters 230 are also formed on the substrate 210 and the light blocking member 220. An overcoat 250 is formed on the color filters 230 and the light blocking member 200. A common electrode 270 is formed on the overcoat 250. The common electrode 270 is made of, for example, a transparent conductive material such as ITO and IZO and has a plurality of cutouts 71.

Each of the cutouts 71 includes a transverse portion extending parallel to the gate line 121 and oblique portions which extend upward and downward making oblique angles with the gate line 121.

Alignment layers 11 and 21 are coated on inner surfaces of the panels 100 and 200, and they may be vertical alignment layers. Polarizers are provided on outer surfaces of the panels 100 and 200, and their polarization axes are perpendicular to each other and for example make an angle of about 45 degrees with the primary edges of the first sub-pixel electrode 193. One of the polarizers may be omitted when the LCD is a reflective LCD.

An LCD according to the present exemplary embodiment may further include a retardation film for compensating the retardation of the liquid crystal layer 3. The LCD may include a backlight unit for supplying light to the polarizers, the retardation film, the panels 100 and 200, and the liquid crystal layer 3.

The liquid crystal layer 3 is in a state of negative dielectric anisotropy, and the liquid crystal molecules 31 in the liquid crystal layer 3 are aligned such that their long axes are substantially vertical to the surfaces of the panels 100 and 200 in the absence of an electric field. Therefore, incident light into the liquid crystal layer 3 can't pass through the crossed polarizers 12 and 22 is blocked.

On the other hand, as mentioned above, the first upper sub-pixel electrode 193 is applied with a data voltage from the first drain electrode 175a and transmits the data voltage to the lower sub-pixel electrode 194.

The pixel electrode applied with a data voltage together with the common electrode applied with a common voltage form a liquid crystal capacitor and generate an electric field in the liquid crystal layer 3. Here, the voltage of the first upper sub-pixel electrode 193 is equal to the voltage of the lower sub-pixel electrode 194, but the strength of the electric field which the liquid crystal molecules over the lower sub-pixel electrode 194 are subject to is different from the strength of the electric field which the liquid crystal molecules over the first upper sub-pixel electrode 193 are subject to. This is because the distance between the lower sub-pixel electrode 194 and the common electrode 270 is different from the distance between the upper sub-pixel electrode 193 and the common electrode 270, and also because the dielectric constants of the gate insulating layer 140 and the passivation layer 180 located over the lower sub-pixel electrode 194 are different from the dielectric constant of the liquid crystal layer 3.

Therefore, a liquid crystal capacitor formed by a pixel electrode 191 and the common electrode 270 may be divided into a first liquid crystal capacitor including the liquid crystal layer 3 disposed between the first upper sub-pixel electrode 193 and the common electrode 270 as its dielectric, a coupling capacitor including the gate insulating layer 140 and the passivation layer 180 disposed over the lower sub-pixel electrode 194 as its dielectric, a second liquid crystal capacitor including the liquid crystal layer 3 disposed over the lower sub-pixel electrode 194 as its dielectric, a voltage drop capacitor including the gate insulating layer 140 disposed between the third storage electrode 137c and the third drain electrode 175c as its dielectric, and a third liquid crystal capacitor including the liquid crystal layer 3 disposed between the first upper sub-pixel electrode 193 and the common electrode 270 as its dielectric.

The above-described LCD may be represented in the equivalent circuit diagram of FIG. 16.

Referring to FIG. 16, a pixel of an LCD according to an exemplary embodiment of the present invention includes a first, a second, and a third TFTs Qa, Qb, and Qc, a first, a second, and a third liquid crystal capacitors Clca1, Clca2, and Clcb, a coupling capacitor Ccp1, and a voltage drop capacitor Ccs. Besides, each pixel further includes a storage capacitor.

The first liquid crystal capacitor Clca1 is connected to the drain of the first TFT Qa. The coupling capacitor Ccp1 is connected between the first TFT Qa and the second liquid crystal capacitor Clca2. The third liquid crystal capacitor Clcb is connected to the drain of the second TFT Qb and the source of the third TFT Qc. The voltage drop capacitor Ccs is connected to the drain of the third TFT Qc. The common electrode 270 is applied with a common voltage Vcom. The first/the second switching element Qa/Qb including a TFT is a three-terminal element provided on the lower panel 100, and it has a control terminal connected to a first gate line Gi, an input terminal connected to a data line Dj, and an output terminal connected to liquid crystal capacitors Clca1 and Clca2/Clcb and a storage capacitor.

The third switching element Qc including a TFT is also a three-terminal element provided on the lower panel 100, and it has a control terminal connected to a second gate line Gi+1, an input terminal connected to a second switching element Qb and a third liquid crystal capacitor Clcb, and an output terminal connected to a voltage drop capacitor Ccs.

The first TFT Qa applies a data voltage from the data line Dj to the first liquid crystal capacitor Clca1 and the coupling capacitor Ccp1 in response to a gate signal from the gate line Gi, and then the coupling capacitor Ccp1 transmit the data voltage having a modified magnitude to the second liquid crystal capacitor Cica2.

The relation between the voltage Va charged across the first liquid crystal capacitor Clca1 and the voltage Vb charged across the second liquid crystal capacitor Clca2 is given as follows.
Vb=Va ×[Ccp1/(Ccp1+Clca2)]

As the term Ccp1/(Ccpl+Clca2) is smaller than one, the voltage Vb charged across the second crystal capacitor Clca2 is always smaller than the voltage Va charged across the first liquid crystal capacitor Clca1.

The second TFT Qb transmits a data voltage from the data line Dj to the third liquid crystal capacitor Clcb in response to a gate signal from the gate line Gi. Then the third TFT Qc transmits a portion of the charged data voltage across the third liquid crystal capacitor Clcb to the voltage drop capacitor Ccs in response to a gate signal from the gate line Gi+1. Therefore, the voltage Vc charged across the second liquid crystal capacitor Clcb is always smaller than the voltage Va charged across the first liquid crystal capacitor Clca1.

Also, the voltage Vb across the second liquid crystal capacitor Clca2 is different from the voltage Vc across the third liquid crystal capacitor Clcb.

In this way, when a potential difference is generated across the first to the third liquid crystal capacitors Clc1, Clc2, and Clcb, an electric field that is substantially vertical to the surfaces of the panels 100 and 200 is generated in the liquid crystal layer 3. Then, the liquid crystal molecules in the liquid crystal layer 3 tilt in response to the electric field such that their long axes become perpendicular to the electric field direction, and the degree of the tilt of the liquid crystal molecules determines the change of the polarization of incident light into the liquid crystal layer 3. This change of the light polarization causes a change of light transmittance through the polarizers, and in this way, the LCD displays images.

The tilt angle of the liquid crystal molecules depends on the strength of the electric field. As the voltage Va of the first liquid crystal capacitor Clca1, the voltage Vb of the second liquid crystal capacitor Clca2, and the voltage of the third liquid crystal capacitor Clcb are different from each other, the tilt angles of the liquid crystal molecules in the respective liquid crystal capacitors Clca1, Clca2, and Clcb are also different from each other, and accordingly, the luminances of the respective liquid crystal capacitors Clca1, Clca2, and Clcb are different from each other. Therefore, the voltage Va of the first liquid crystal capacitor Clca1, the voltage Vb of the second liquid crystal capacitor Clca2, and the voltage Vc of the third liquid crystal capacitor Clcb can be adjusted so that an image viewed from a lateral side is most similar to an image viewed from the front, thereby improving the lateral visibility.

The appropriate ratio of the voltage Va of the first liquid crystal capacitor Clca1, the voltage Vb of the second liquid crystal capacitor Clca2, and the voltage Vc of the third liquid crystal capacitor Clcb may be adjusted by varying the capacitance of the coupling capacitor Ccp1. The capacitance of the coupling capacitor Ccp1 can be varied by adjusting the overlapped area of the lower sub-pixel electrode 194 and the common electrode 270 and the dielectric constant of the gate insulating layer 140 or the passivation layer 180 which functions as a dielectric. The capacitance of the voltage drop capacitor Ccs can be varied by adjusting the overlapped area of the third storage electrode 137c and the third drain electrode 175c and the distance there between.

The voltage Vb or Vc of the second or the third liquid crystal capacitor Clca2 or Clcb is, for example, about 0.55 to about 0.85 times the voltage Va of the first liquid crystal capacitor Clcal.

The edges of the sub-pixel electrodes 193, 194, and 195 and the cutouts 71 of the common electrode 270 distort the electric field to generate horizontal components of the electric field, which determines the tilt direction of the liquid crystal molecules, and the horizontal components of the electric field are perpendicular to the edges of the sub-pixel electrodes 193, 194, and 195 and the edges of the cutouts 71.

Referring to FIG. 12, a cutout 71 and a gap 94 between the first and the second upper sub-pixel electrodes 193 and 194 divides a pixel electrode 191 into a plurality of sub-areas, each of which has two oblique major edges. As the liquid crystal molecules on each sub-area tilt vertically to the major edges, the azimuthal distribution of the tilt directions is localized to four directions. Like this, if tilt directions of the liquid crystal molecules are various, the reference viewing angle of the LCD is increased.

Each sub-area is divided into a plurality of small regions by the edges of the sub-pixel electrodes 193, 194, and 195, and as described above, the tilt angles of the liquid crystal molecules on the respective small regions are different from each other, thereby improving the visibility. Also, as the direction of the equipotential lines or the electric field around the boundaries of each small region is temporarily varied to generate horizontal components of the electric field, the response time of the liquid crystal is decreased.

Also, the transmittance is decreased as much as the area occupied by the cutouts in the prior LCDs including cutouts in the pixel electrode 191. However, in the LCD according to the present exemplary embodiment, the transmittance is significanUy improved because of very few cutouts. Moreover, even though cutouts are formed in the pixel electrode 191, the distance between cutouts can be sufficiently wide because horizontal components of the electric field are generated near the boundaries of each small region, that is, the boundaries of the lower sub-pixel electrode 194 and the first and the second upper sub-pixel electrodes 193 and 195.

The shape and configuration of the sub-pixel electrodes 193, 194, and 195 and the cutouts 71 may be variously modified, and the cutout 71 may be substituted with a protrusion, a depression, or a slope member. The protrusion or the slope member may be made of an organic material or an inorganic material and disposed on or under the field generating electrodes 191 and 270.

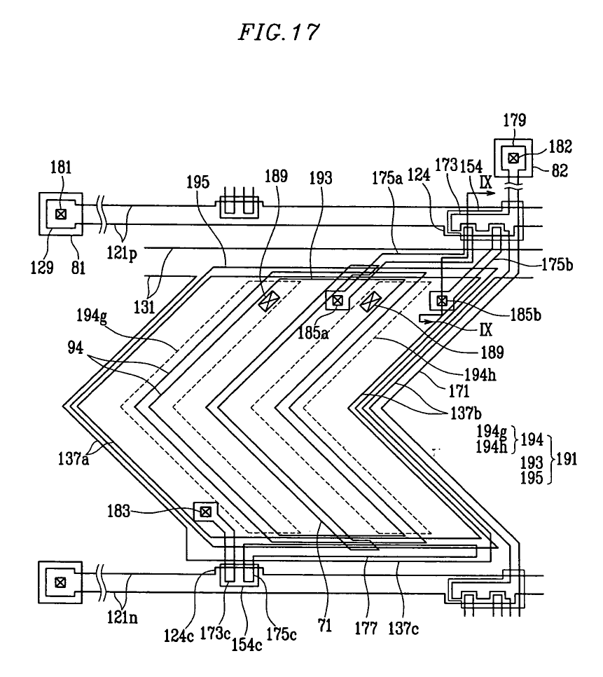

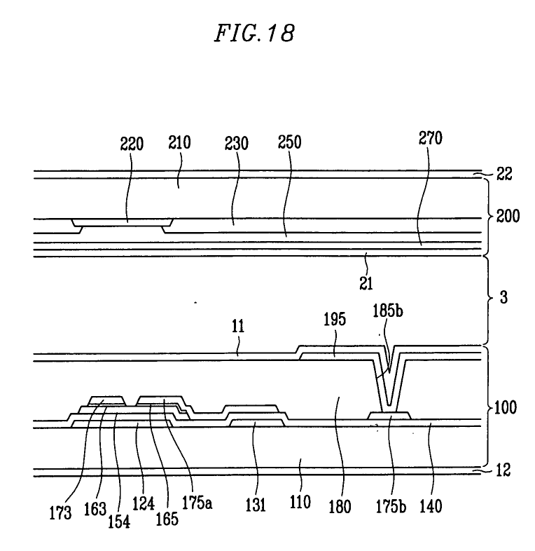

Now, a liquid crystal panel assembly according to another exemplary embodiment of the present invention will be described in detail with reference to FIG. 17 and FIG. 18.

FIG. 17 is a layout view of a liquid crystal panel assembly according to another exemplary embodiment of the present invention, and FIG. 18 is a cross-sectional view of the liquid crystal panel assembly illustrated in FIG. 17 taken along the line XVIII-XVIII.

The LCD illustrated in FIG. 17 and FIG. 18 also includes a TFT array panel 100, a common electrode panel 200, a liquid crystal layer 3 interposed between the two panels 100 and 200, and polarizers 11 and 21 attached to outer surfaces of the two panels 100 and 200.

Regarding the TFT array panel 100, a plurality of gate lines 121, storage electrode lines 131, and lower sub-pixel electrodes 194 are formed on an insulating substrate 110. Each gate line 121 includes gate electrodes 124 and 124c and an end portion 129. Each storage electrode line 131 includes storage electrodes 137a, 137b, and 137c. A gate insulating layer 140 is formed on the gate lines 121, the storage electrode lines 131, and the lower sub-pixel electrodes 194. A plurality of semiconductors 154 and 154c are formed on the gate insulating layer 140, and a plurality of ohmic contacts 163, 165, 163c, and 165c are formed on the semiconductors 154 and 154c. Data conductors including a plurality of data lines 171, source conductors 173c, and drain electrodes 175a and 175b are formed on the ohmic contacts 163, 165, 163c, and 165c and the gate insulating layer 140. Each data line 171 includes source electrodes 173 and an end portion 179. A passivation layer 180 is formed on the data conductors 171, 173c, 175a, and 175b and the exposed portions of the semiconductors 154 and 154c, and the passivation layer 180 and the gate insulating layer 140 have a plurality of contact holes 181, 182, 183, 185a, 185b, and 189. A plurality of first and second upper sub-pixel electrodes 193 and 195 and a plurality of contact assistants 81 and 82 are formed on the passivation layer 180. An alignment layer 11 is formed on the upper sub-pixel electrodes 193 and 195, the contact assistants 81 and 82, and the passivation layer 180.

Regarding the common electrode panel 200, a light blocking member 220, a common electrode 270 having cutouts 71, and an alignment layer 21 are sequentially formed on an insulating layer 210.

The first and the second upper sub-pixel electrodes 193 and 195 and the lower sub-pixel electrode 194 form a pixel electrode 191. The lower sub-pixel electrode 194 comprises a plurality of lower electrode pieces 194g and 194h. However, unlike the LCD illustrated in FIG. 12, in the LCD according to the present exemplary embodiment, the pixel electrode 191 includes a pair of curved edges parallel to each other. That is, each of the lower sub-pixel electrode 194, the first upper sub-pixel electrode 193, and the second upper sub-pixel electrode 195 forming a pixel electrode 191 includes at least one parallelogrammic electrode portion 196 illustrated in FIG. 11a and one parallelogrammic electrode portion 197 illustrated in FIG. 11b.

Each of the lower sub-pixel electrode 194, the first upper sub-pixel electrode 193, and the second upper sub-pixel electrode 195 illustrated in FIG. 17 has a shape in which a left inclination electrode portion 197 and a right inclination electrode portion 196 are vertically connected.

The first upper sub-pixel electrode 193 is located in the middle of the pixel electrode 191, and the second upper sub-pixel electrode 195 comprises two electrode pieces 195e and 195f. The cutout 71 of the common electrode 270 is substantially parallel to the curved edges of the pixel electrode 191. The cutout 71 includes oblique portions bisecting the pixel electrode 191 and the first/the second upper sub-pixel electrode (193/195) and transverse portions which make obtuse angles with respect to the oblique portions and overlap the transverse edges of the pixel electrode 191.

Meanwhile, in the structure illustrated in FIG. 17, the direction of a secondary electric field due to the voltage difference between the pixel electrodes 191 coincides with the direction of the horizontal component of the primary electric field generated at the boundaries of the upper sub-pixel electrodes 193 and 195 and at the boundaries of the cutout 71. Consequently, the secondary electric field between the pixel electrodes 191 enhances the determination of the tilt directions of the liquid crystal molecules.

Numerous characteristics of the LCD illustrated in FIG. 12 to FIG. 15 may be also applied to the LCD illustrated in FIG. 8.

According to the exemplary embodiments of the present invention, the response speed of the liquid crystal is improved while also ensuring improved transmittance.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A liquid crystal display comprising:
a transparent substrate;
a transparent conductor formed on the transparent substrate;
a gate line formed on the transparent conductor;
a data line intersecting the gate line;
a pixel electrode formed on a pixel area defined by the gate line and the data line, the pixel electrode comprising a first sub-pixel electrode, a second sub-pixel electrode, and a third sub-pixel electrode; and
a switching element electrically connected to the gate line, the data line, and the pixel electrode,
wherein the first sub-pixel electrode and the second sub-pixel electrode are electrically connected to each other, and the third sub-pixel electrode is isolated from the first and the second sub-pixel electrodes.

2. The liquid crystal display of claim 1, wherein the second sub-pixel electrode includes the same material as the transparent conductor.

3. The liquid crystal display of claim 2, wherein the second sub-pixel electrode is disposed in a different layer from the first and third sub-pixel electrodes.

4. The liquid crystal display of claim 3, wherein the second sub-pixel electrode is disposed in the same layer as the transparent conductor.

5. The liquid crystal display of claim 1, wherein the second sub-pixel electrode overlaps the third sub-pixel electrode.

6. The liquid crystal display of claim 1, wherein the area of the second sub-pixel electrode or the third sub-pixel electrode is about 0.2 to about 2 times the area of the first sub-pixel electrode.

7. A liquid crystal display comprising:
a first display panel comprising first and second sub-pixel electrodes electrically connected to each other, a third sub-pixel electrode isolated from the first and second sub-pixel electrodes, and a first insulating layer covering the second sub-pixel electrode and not covering the first sub-pixel electrode;
a second display panel opposing the first display panel and comprising a common electrode; and
a liquid crystal layer interposed between the first display panel and the second display panel.

8. The liquid crystal display of claim 7, wherein the first insulating layer is disposed under the first and third sub-pixel electrodes.

9. The liquid crystal display of claim 8, wherein the second sub-pixel electrode overlaps the third sub-pixel electrode.

10. The liquid crystal display of claim 9, further comprising:
a thin film transistor connected to the first sub-pixel electrode or the second sub-pixel electrode;
a gate line connected to the thin film transistor;
a data line connected to the thin film transistor; and
a second insulating layer formed between the gate line and the data line,
wherein the first insulating layer is disposed over the thin film transistor, the gate line, and the data line.

11. The liquid crystal display of claim 10, wherein the second sub-pixel electrode is disposed over the second insulating layer.

12. The liquid crystal display of claim 10, wherein the second sub-pixel electrode is disposed under the second insulating layer.

13. The liquid crystal display of claim 10, wherein the thickness of the first or the second insulating layer ranges from about 200 nanometers (nm) to about 1000 nm.

14. The liquid crystal display of claim 10, wherein the dielectric constant of the first or the second insulating layer ranges from about 2 to about 8.

15. The liquid crystal display of claim 10, wherein the area of the second sub-pixel electrode or the third sub-pixel electrode is about 0.2 to about 2 times the area of the first sub-pixel electrode.

16. The liquid crystal display of claim 10, wherein the second sub-pixel electrode is made of the same material as the gate line or the data line.

17. The liquid crystal display of claim 10, wherein the second sub-pixel electrode is made of the same material as the first and third sub-pixel electrodes.

18. The liquid crystal display of claim 10, further comprising a polarizer provided on at least one of the first and second display panels.

19. The liquid crystal display of claim 18, wherein each of the first and third sub-pixel electrodes includes at least one boundary that forms an oblique angle with respect to a polarization axis of the polarizer.

20. The liquid crystal display of claim 19, wherein the oblique angle is about 45 degrees.

21. The liquid crystal display of claim 7, wherein the outer boundary of the first to third sub-pixel electrodes is rectangular.

22. The liquid crystal display of claim 7, wherein a pair of boundaries of the outer boundary of the first to third sub-pixel electrodes is curved parallel to each other.

23. A liquid crystal display comprising:
a gate line;
a data line intersecting the gate line;
a switching element connected to the gate line and the data line;
a first liquid crystal capacitor connected to the switching element;
a first coupling capacitor connected to the switching element;
a second liquid crystal capacitor connected to the first coupling capacitor;
a second coupling capacitor connected to the switching element; and
a third liquid crystal capacitor connected to the second coupling capacitor.

24. The liquid crystal display of claim 23, wherein a distance between two terminals of the first liquid crystal capacitor is different from a distance between two terminals of the second liquid crystal capacitor.

25. The liquid crystal display of claim 24, wherein the voltage of the second or the third liquid crystal capacitor is about 0.55 to about 0.85 times a voltage of the first liquid crystal capacitor.

26. A liquid crystal display comprising:
a first and a second sub-pixel electrode electrically connected to each other;
a third sub-pixel electrode separated from the first and the second sub-pixel electrodes, the third sub-pixel electrode together with the first and the second sub-pixel electrodes forming a pixel electrode;
an insulating layer which covers the second sub-pixel electrode and does not cover the first sub-pixel electrode;
a first switching element connected to the first sub-pixel electrode;
a second and a third switching element connected to the third sub-pixel electrode; and
a capacitor connected to the third switching element.

27. The liquid crystal display of claim 26, further comprising:
a first gate line connected to the first and the second switching elements;
a second gate line connected to the third switching element; and
a data line connected to the first and the second switching elements.

28. The liquid crystal display of claim 26, further comprising a storage electrode overlapping the pixel electrode.

29. The liquid crystal display of claim 28, wherein the capacitor includes a drain electrode of the third switching element and the storage electrode as two terminals.

30. The liquid crystal display of claim 26, wherein the thickness of the insulating layer is about 200 nanometers (nm) to about 1,000 nm.

31. The liquid crystal display of claim 26, wherein the dielectric constant of the insulating layer is about 2 to about 8.

32. The liquid crystal display of claim 26, wherein the area of the second sub-pixel electrode or the third sub-pixel electrode is about 0.2 times to about twice the area of the first sub-pixel electrode.

33. The liquid crystal display of claim 27, wherein the second sub-pixel electrode is made of the same material as the first and the second gate lines or the data line.

34. The liquid crystal display of claim 30, wherein the second sub-pixel electrode is made of the same material as the first and the third sub-pixel electrodes.

35. The liquid crystal display of claim 27, wherein each of the first and the third sub-pixel electrodes includes at least one boundary which makes an oblique angle with respect to the first and the second gate lines.

36. The liquid crystal display of claim 35, wherein the oblique angle is about 45 degrees.

37. The liquid crystal display of claim 26, wherein the outer boundary of the first to the third sub-pixel electrodes is rectangular.

38. The liquid crystal display of claim 26, wherein each of the first to the third sub-pixel electrodes includes at least two parallelogrammic electrode pieces which have different inclination directions from each other.
